(19) United States
(12) Patent Application Publication
(10) Pub. No.: US 2025/0283663 A1
(43) Pub. Date: Sep. 11, 2025

(54) DISCHARGE DEVICE FOR SINTERING FURNACE

(71) Applicants: TINCI MATERIALS (TAIZHOU) CO., LTD., Taizhou (CN); GUANGZHOU TINCI MATERIALS TECHNOLOGY CO., LTD., Guangzhou (CN)

(72) Inventors: Ke YANG, Taizhou (CN); Haishen SONG, Taizhou (CN); Chao LIU, Taizhou (CN); Litao SHI, Taizhou (CN)

(21) Appl. No.: 19/216,765

(22) Filed: May 23, 2025

Related U.S. Application Data
(63) Continuation of application No. PCT/CN2024/094017, filed on May 17, 2024.

(30) Foreign Application Priority Data
Apr. 9, 2024 (CN) 202410423391.1
Apr. 9, 2024 (CN) 202420728588.1

(51) Int. Cl. F27D 15/00; F27D 3/00; F27D 3/16

(52) U.S. Cl. CPC F27D 15/00; F27D 3/16; F27D 2003/0075

(57) ABSTRACT

Provided is a discharge device for a sintering furnace. The discharge device includes a material bin connected to a body of the sintering furnace, a conveying hopper, a first valve assembly, a first gas exchange assembly and a controller. The conveying hopper has a feed inlet, a discharge outlet and a first gas exchange port. The first valve assembly is located at the feed channel to control opening or closing of the feed channel. The first gas exchange assembly is connected to the first gas exchange port. The first gas exchange assembly outputs gas from the first gas exchange port and deliver protective gas into the conveying hopper. The controller is electrically connected to the first gas exchange assembly and the first valve assembly to control the first gas exchange assembly to be activated when the conveying hopper has completed conveying and the first valve assembly is closed.

### CROSS-REFERENCE TO RELATED APPLICATIONS

This application is a continuation of International Application No. PCT/CN2024/094017, filed on May 17, 2024, which is based on and claims priorities to Chinese Patent Application No. 202410423391.1, filed on Apr. 9, 2024, and Chinese Patent Application No. 202420728588.1, filed on Apr. 9, 2024, the entire disclosures of which are incorporated herein by reference.

### FIELD

The present disclosure relates to the field of sintering furnace technologies, and particularly, to a discharge device for a sintering furnace.

### BACKGROUND

Currently, among lithium-ion battery positive electrode materials, a lithium iron phosphate positive electrode material has become a most promising new generation of a safe and environmentally friendly lithium-ion power battery positive electrode material due to its advantages such as high specific capacity, low cost, no environmental pollution, good safety, and thermal stability. It can be widely applied in fields such as new energy vehicles, energy storage devices, uninterruptible power supplies, and power tools, presenting a very broad market prospect.

Current industrial production of the lithium iron phosphate positive electrode materials mostly adopts a high-temperature solid-phase synthesis method. That is, main raw materials such as lithium salt, iron salt, phosphate salt, and other additives are uniformly mixed in a stoichiometric ratio, and heated and held at a constant temperature for sintering to obtain the lithium iron phosphate positive electrode material. The existing large-scale production of the lithium iron phosphate positive electrode materials predominantly adopts sintering equipment such as roller hearth kilns, pusher plate kilns, and rotary kilns. Meanwhile, in order to prevent oxidation of divalent iron during synthesis of the lithium iron phosphate materials and ensure product consistency, the materials are synthesized in a closed state, and a large amount of protective gas needs to be continuously introduced throughout the entire material production process to prevent the oxidation of the divalent iron during the synthesis of the lithium iron phosphate materials and ensure the product consistency.

Based on purposes of improving production capacity, reducing cost, and increasing efficiency, the equipment is large in size and heavy in weight. In order to ensure installation stability and process stability, challenges are posed to an overall structure of the equipment, especially a layout and a design of a discharge device. There is still some room for improvement in the discharge device for a sintering furnace.

### SUMMARY

The present disclosure aims to solve at least one of the technical problems in the related art to some extent.

To this end, an objective of the present disclosure is to provide a discharge device for a sintering furnace, which is capable of effectively isolating air backflow and ensuring a stable atmosphere in the sintering furnace and product quality.

The discharge device for the sintering furnace according to embodiments of the present disclosure includes a material bin, a conveying hopper, a first valve assembly, a first gas exchange assembly, and a controller. The material bin is configured to be connected to a body of the sintering furnace to collect sintered material. The conveying hopper has a feed inlet, a discharge outlet, and a first gas exchange port. A feed channel is disposed between the feed inlet and the material bin and connected to the feed inlet and the material bin. The first valve assembly is disposed at the feed channel and configured to control opening or closing of the feed channel. The first gas exchange assembly is connected to the first gas exchange port. The first gas exchange assembly is configured to output gas from the first gas exchange port and deliver protective gas into the conveying hopper. The protective gas is same as protective gas inside the body. The controller is electrically connected to the first gas exchange assembly and the first valve assembly to control the first gas exchange assembly to be activated when the conveying hopper has completed conveying and the first valve assembly is closed.

With the discharge device for the sintering furnace according to the embodiments of the present disclosure, a communication state between the conveying hopper and the material bin is controlled by providing the first valve assembly at the feed channel between the material bin and the feed inlet of the conveying hopper. The first valve assembly is promptly closed when the material from the material bin has been received by the conveying hopper to reduce a possibility of residual air flowing into the material bin through the feed channel and then into the sintering furnace. In this way, the production process of the sintering furnace is prevented from being affected.

The first gas exchange assembly is connected to the first gas exchange port of the conveying hopper, and the protective gas is continuously delivered to the conveying hopper. Thus, air inside the conveying hopper can be effectively replaced. In this way, during a process when the first valve assembly is opened and the material enters the conveying hopper from the material bin, a possibility of the air flowing backwards into the material bin is avoided. Thus, the air is prevented from flowing into the body of the sintering furnace to maintain purity of the atmosphere inside the sintering furnace.

The controller is provided to control the first gas exchange assembly and the first valve assembly. The controller is configured to control the first gas exchange assembly to be activated easily when the conveying hopper has completed the conveying and the first valve assembly is closed. In this way, gas replacement efficiency of the discharge device is improved.

Additional aspects and advantages of the present disclosure will be provided at least in part in the following description, or will become apparent in part from the following description, or can be learned from the practice of the present disclosure.

### BRIEF DESCRIPTION OF THE DRAWINGS

FIG. 1 is a schematic structural view of a discharge device according to some embodiments of the present disclosure.

FIG. 2 is a schematic structural view of a conveying hopper according to some embodiments of the present disclosure.

FIG. 3 is a schematic structural view of a conveying hopper according to some other embodiments of the present disclosure.

FIG. 4 is a schematic structural view of a discharge device according to some other embodiments of the present disclosure.

FIG. 5 is a schematic view of a position of a high-pressure gas port in a conveying hopper in the present disclosure.

FIG. 6 is a schematic view of a position of a negative-pressure gas port in a conveying hopper in the present disclosure.

### REFERENCE NUMERALS

discharge device 100,
material bin 10, inlet 11, outlet 13, second gas exchange port 14,
conveying hopper 20, feed channel 21, feed inlet 22, discharge outlet 23, discharge channel 24,
first gas exchange port 25, first gas exchange inlet 251, first gas exchange outlet 252,
gas port 26, high-pressure gas port 261, negative-pressure gas port 262,
first valve assembly 30, feed valve 31, first feed control valve 32, second feed control valve 33, third feed control valve 34,
first gas exchange assembly 40, gas exchange intake channel 41, first gas exchange channel 42, first gas filter 43, first gas exchange control valve 44, second gas exchange control valve 45,
intake pipe 50, high-pressure trunk pipe 51, branch pipe 52, gas-pressure regulator 53,
second valve assembly 60, second gas exchange assembly 70, second gas filter 71, fourth gas exchange control valve 72,
controller 80, dust removal system 90.

### DETAILED DESCRIPTION OF THE EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the accompanying drawings are illustrative, and are intended to explain rather than limit the present disclosure.

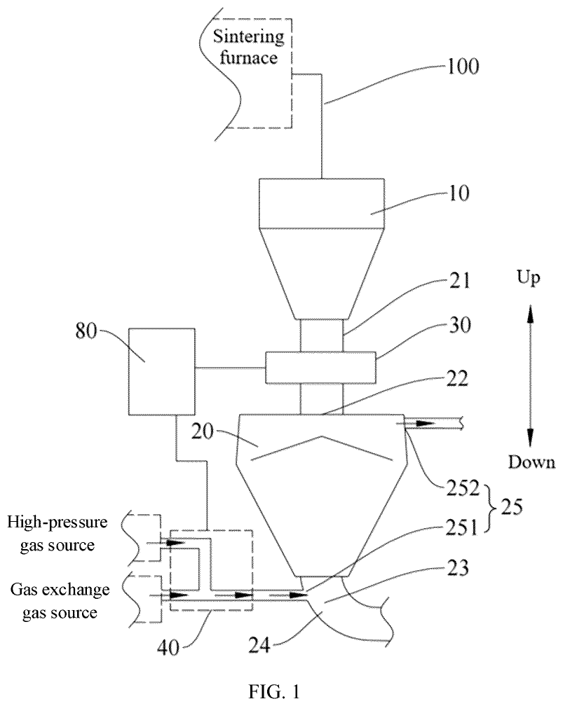

A discharge device 100 according to embodiments of the present disclosure will be described below with reference to FIGS. 1 to 6. An application field of the discharge device 100 is not limited. For example, the discharge device 100 can be applied in a sintering furnace or other equipment that requires the discharge device 100.

It should be noted that the sintering furnace of the present disclosure is used for sintering lithium iron phosphate. Sintering process of lithium iron phosphate needs to be performed in a protective atmosphere. Protective gas needs to be continuously introduced into the sintering furnace. Moreover, after the sintering is completed, a produced material still remains at a high temperature for a certain period of time and is easily oxidized by oxygen in the air upon contacting with air, converting divalent iron into trivalent iron. In this way, iron oxide (Fe₂O₃) and lithium phosphate (Li₃PO₄) are generated, which affects product consistency, and leads to capacity attenuation and performance degradation or even failure of a lithium-ion battery in subsequent applications, affecting its cycle life. Therefore, after lithium iron phosphate is sintered and before it is completely cooled, it must be strictly isolated from the air to ensure product quality.

In addition, due to a large size and a heavy weight of the sintering furnace apparatus, its installation height is not set to be high to ensure installation stability. After the sintering, the material is generally discharged by its own gravity. The position of the discharge device for the material needs to be lower than a body of the sintering equipment, and some structures need to be set below a ground surface. In this case, compressed air is required to convey the material to a storage material bin. Residual air after the conveyance may return through a tail of a furnace chamber of the sintering furnace and flow into the furnace chamber from the tail of the furnace chamber, affecting an inert gas atmosphere inside the furnace chamber, leading to an increase in an oxygen content, which directly affects a sintering effect of the sintering furnace. Therefore, the discharge device and the tail of the furnace chamber of the sintering furnace need to be sealed to prevent external air/the compressed air from returning and flowing into the furnace chamber from the tail of the furnace chamber.

To solve the above problems, the present disclosure provides a discharge device 100.

According to an embodiment of the present disclosure, as illustrated in FIG. 1, the discharge device 100 includes a material bin 10 and a conveying hopper 20. The material bin 10 is configured to be connected to a body of the sintering furnace to collect sintered material.

The conveying hopper 20 has a feed inlet 22. A feed channel 21 is disposed between the feed inlet 22 and the material bin 10 and connected to the feed inlet 22 and the material bin 10.

The sintered material can enter the feed channel 21 through the material bin 10.

As illustrated in FIG. 1, the conveying hopper 20 includes a feed inlet 22, a discharge outlet 23, and a first gas exchange port 25. The feed inlet 22 enables the material to smoothly enter the conveying hopper 20, and the feed channel 21 serves to connect the material bin 10 to the conveying hopper 20 to ensure smooth conveyance of the material.

As illustrated in FIGS. 1 to 4, the discharge device 100 further includes a first valve assembly 30 disposed at the feed channel 21 and configured to control opening or closing of the feed channel 21. The first valve assembly 30 can accurately control the opening or closing of the feed channel 21 during material conveyance. The first valve assembly 30 is opened when the material needs to be fed from the material bin 10 to the conveying hopper 20, and the first valve assembly 30 is closed when the material does not need to be fed from the material bin 10 to the conveying hopper 20.

In addition, the first valve assembly 30 is further configured to isolate flowing of gas between the material bin 10 and the conveying hopper 20. After the material is fed into the conveying hopper 20, the first valve assembly 30 is in a closed state. In this case, a tight barrier is formed in the feed channel 21, ensuring that air inside the conveying hopper 20 does not flow into the material bin 10 through the feed channel 21, thereby preventing the air from flowing into the body of the sintering furnace.

In sintering process, an atmosphere in the furnace, such as an oxygen content in the atmosphere of the furnace, typically needs to be strictly controlled to avoid an adverse effect on the material. If the air accidentally flows into the body of the sintering furnace, the oxygen content in the atmosphere in the furnace increases, resulting in a decrease in quality of the material or generation of an unnecessary by-product. Therefore, it is very important to maintain purity of the atmosphere in the furnace.

Therefore, after the material inside the conveying hopper 20 has been completely conveyed, internal gas needs to be replaced before a next feeding to avoid gas backflow.

In the discharge device 100 according to some embodiments of the present disclosure, the first valve assembly 30 at least includes a plurality of control valves arranged at the feed channel 21.

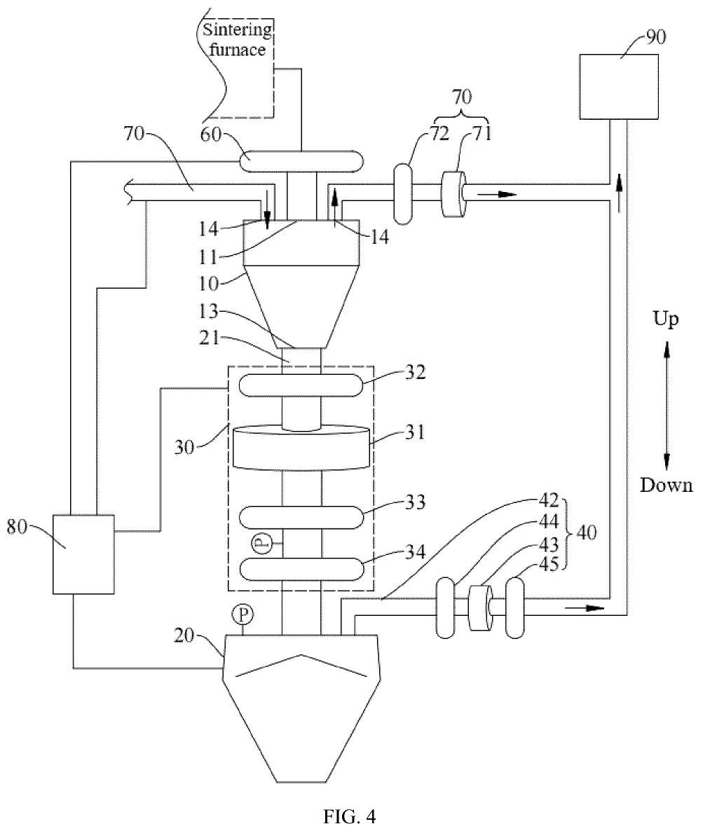

As illustrated in FIG. 4, the plurality of control valves includes a feed valve 31, a first feed control valve 32, a second feed control valve 33, and a third feed control valve 34. The first feed control valve 32 is located upstream of the feed valve 31, and the second feed control valve 33 and the third feed control valve 34 are located downstream of the feed valve 31.

The opening or the closing of the discharge channel 21 is better controlled by the first valve assembly 30 to realize precise control of a flow rate of the material.

For example, the flow rate of the material in the feed channel 21 is adjusted by the feed valve 31. When it is necessary to increase/decrease the flow rate of the material, a rotational speed of the feed valve 31 can be adjusted to achieve a purpose of increasing/decreasing the flow rate.

For another example, when it is necessary to start or stop conveying the material, the first feed control valve 32, the second feed control valve 33, and the third feed control valve 34 may be simultaneously opened or closed to realize the opening or closing of the feed channel 21.

The arrangement of the first valve assembly 30 can effectively improve gas tightness of the feed channel 21 while not causing structural redundancy and controlling the cost, ensuring that the residual air in the conveying hopper 20 cannot flow into the material bin 10 through the feed channel 21 after the material is conveyed by the conveying hopper 20. In this way, the gas backflow is reduced, which is beneficial to controlling the oxygen content of the atmosphere in the sintering furnace. Thus, the product consistency is ensured. In addition, such arrangement also has a certain fault response capability. For example, if a failure occurs in the feed valve 31 and causes material blockage, the first feed control valve 32 upstream can be quickly closed to repair the feed valve 31, to prevent the failure from escalating. Meanwhile, the faulty component may be replaced or repaired as needed to ensure stable operation of the entire discharge device 100.

In an embodiment illustrated in FIG. 4, an inter-valve gas pressure detector is further provided between the second feed control valve 33 and the third feed control valve 34 that are located downstream of the feed valve 31. A gas pressure between the two control valves is monitored by the inter-valve gas pressure detector, which can accurately sense magnitude and change of the gas pressure. A flow state of the material in a pipe and whether there are abnormal conditions such as blockage and leakage can be determined based on received gas pressure data.

When an abnormality is detected by the inter-valve gas pressure detector, the opening and closing conditions of the second feed control valve 33, the third feed control valve 34, and other related valves are adjusted to ensure normal discharge of the material and prevent the air in the conveying hopper 20 from flowing backwards into the material bin 10 and the sintering furnace. With such arrangement, production accidents that may be caused by an abnormal gas pressure are effectively prevented, and stability and reliability of the discharge device 100 are improved.

Optionally, the feed valve 31 is a feed valve of a star shape. The feed valve of this type usually is composed of a central shaft and a number of blades uniformly distributed around an axle center. As the central shaft rotates, the blades push the material forwards in the discharge channel, thereby controlling the flow rate of the material. The feed valve of the star shape is particularly suitable for handling materials that are highly viscous or prone to agglomeration, for it can effectively prevent the material blockage by rotating.

In order to prevent the air in the conveying hopper 20 from flowing backwards into the material bin 10, the discharge device 100 further includes a first gas exchange assembly 40 connected to the first gas exchange port 25 and configured to output gas from the first gas exchange port 25 and deliver protective gas into the conveying hopper 20. The protective gas is same as protective gas in the body of the sintering furnace. The first gas exchange port 25 formed at the conveying hopper 20 is not limited to an embodiment. For example, in some embodiments, the first gas exchange port 25 may be an inlet and an outlet. After gas in the conveying hopper 20 is sucked by the first gas exchange assembly 40 through the first gas exchange port 25, the protective gas is delivered to the conveying hopper 20 by the first gas exchange assembly 40 through the first gas exchange port 25. In this case, the operations of gas suction and inflation are performed alternately rather than simultaneously. In other embodiments, the first gas exchange port 25 includes a first gas exchange inlet 251 and a first gas exchange outlet 252. The first gas exchange inlet 251 is only configured to deliver gas to the conveying hopper 20, and the first gas exchange outlet 252 is only configured to suck gas from the conveying hopper 20. In this case, the operations of gas suction and inflation may be performed alternately or simultaneously.

Meanwhile, after the material bin 10 feeds the material to conveying hopper 20, some residual material may remain, and the residual material of this part is accumulated at the outlet 13 due to its own gravity to serve as a material seal, which can prevent the gas backflow.

In an embodiment of the present disclosure, when the first valve assembly 30 is closed and ready to receive a next batch of materials into the conveying hopper 20, the same protective gas as that in the body of the sintering furnace is preemptively delivered into the conveying hopper 20 by the first gas exchange assembly 40, ensuring that the conveying hopper 20 is in an environment filled with the protective gas before receiving the new materials.

The purpose of replacing the air in the conveying hopper 20 is to prevent residual air from remaining after the materials inside the conveying hopper 20 are conveyed. When the new materials from the material bin 10 is received by the conveying hopper 20, the residual air flows into the material bin 10 and into the body of the sintering furnace through the material bin 10, thereby maintaining the purity of the atmosphere in the furnace. If the air accidentally flows into the furnace, the oxygen content in the furnace increases, and the materials in the furnace reacts with the oxygen, resulting problems such as in uneven sintering of the materials or the production of other by-products.

As illustrated in FIG. 1, the discharge device 100 further includes a controller 80. The controller 80 is electrically connected to the first gas exchange assembly 40 and the first valve assembly 30 to control the first gas exchange assembly 40 to be activated when the conveying hopper 20 has completed conveying and the first valve assembly 30 is closed.

The controller 80 serves to coordinate and manage operation of various assemblies. The controller 80 is electrically connected to the first gas exchange assembly 40 and the first valve assembly 30 to allow each of the first gas exchange assembly 40 and the first valve assembly 30 to receive and send an electrical signal, to accurately control an operating state of each of the first gas exchange assembly 40 and the first valve assembly 30. In this way, uncertainties during operation are reduced, and the reliability of the discharge device 100 and production efficiency of the sintering furnace are improved.

In a workflow of the sintering furnace, when the task of conveying the material is completed by the conveying hopper 20, the first valve assembly 30 is promptly closed to ensure sealing of the material bin 10. In this case, the closed state of the first valve assembly 30 is detected by the controller 80, which is determined as a trigger condition, and an opening signal is sent to the first gas exchange assembly 40 by the controller 80 in response to the trigger condition.

After receiving the opening signal, the first gas exchange assembly 40 starts to operate in such a manner that the protective gas is delivered to the conveying hopper 20 to replace the residual air in the conveying hopper 20 after the conveying is completed and prepare for a next operating cycle of unloading the material into the conveying hopper 20 from the material bin 10 and then conveying the material from the conveying hopper 20. The controller 80 ensures that the conveying hopper 20 can promptly obtain an environment filled with the protective gas each time the material is conveyed by the conveying hopper 20, thereby preventing the air in the conveying hopper 20 after the conveying from flowing into the material bin 10 and then into the body of the sintering furnace when the material is unloaded into the conveying hopper 20 from the material bin 10 next time. In this way, the atmosphere in the furnace and the sintering quality of the material are ensured.

According to an embodiment of the present disclosure, an operating cycle is described as follows.

An initial stage: a material unloading signal from an upstream process is received by the conveying hopper 20 in which replacement occurs and that is filled with protective gas, and then the first valve assembly 30 is controlled by the controller 80 to be opened, and a material starts to enter the conveying hopper 20 from the material bin 10. The controller 80 is configured to control the first gas exchange control valve 44 and the second gas exchange control valve 45 to be opened when the material is unloaded to the conveying hopper 20 from the material bin 10.

A conveying stage: a material continuously enters the conveying hopper 20. The controller 80 is configured to, when a material inside the conveying hopper 20 reaches a predetermined target weight, control the first valve assembly 30 to close and control input of the high-pressure gas into the conveying hopper 20, and the material inside the conveying hopper 20 begins to be conveyed to a subsequent process. The controller 80 is configured to control the first gas exchange control valve 44 and the second gas exchange control valve 45 to close when the material is conveyed backwards by the conveying hopper 20.

A gas exchange stage: when the conveying of the material in the conveying hopper 20 is completed, the controller 80 is configured to control the first gas exchange assembly, the first gas exchange control valve 44, and the second gas exchange control valve 45 to be activated, and the gas exchange gas source is configured to deliver protective gas to the conveying hopper 20 through the gas exchange inlet to replace residual air in the conveying hopper 20 after the conveying is completed. After the replacement for a predetermined target duration, the gas exchange gas source is closed. In this case, the conveying hopper 20 is filled with the protective gas.

Next operating cycle: after the gas exchange is completed, the operating cycle of the initial stage→the conveying stage→the gas exchange stage continues.

Through the above operating cycle, the discharge device 100 can ensure that after the material is conveyed each time, the conveying hopper 20 can be quickly filled with the protective gas, thereby effectively preventing the air from flowing into the body of the sintering furnace and ensuring the atmosphere and the material quality in the furnace. Meanwhile, a high degree of automation and precise control of the entire workflow can also greatly improve the production efficiency and the reliability of the sintering furnace.

Optionally, the controller 80 is also highly programmable and flexible, and can adjust operating parameters of the first gas exchange assembly 40 and the first valve assembly 30, such as an opening time point and a closing time point, a flow rate of the gas, etc., according to actual production needs, to adapt to different production environments and requirements.

In some embodiments, at least one of the first valve assembly 30 and the first gas exchange assembly 40 is provided with a sensor. The sensor can monitor an operating state of the first valve assembly 30 and/or the first gas exchange assembly 40 in real time, promptly monitor an abnormal condition. In this way, safety of the discharge device 100 is improved.

The discharge device 100 for the sintering furnace according to the present disclosure provides a safer and more reliable conveyance environment for the material, and provides a strong guarantee for continuous and efficient operation of the sintering furnace.

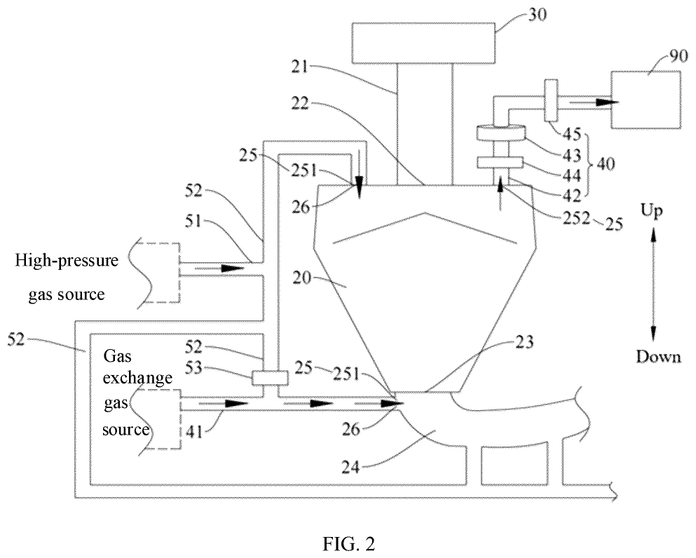

In the discharge device 100 according to some embodiments of the present disclosure, as illustrated in FIGS. 2 and 3 and FIGS. 5 and 6, the conveying hopper 20 has at least one gas port 26 for generating a pressure difference between inside and outside of the conveying hopper 20 to convey the material.

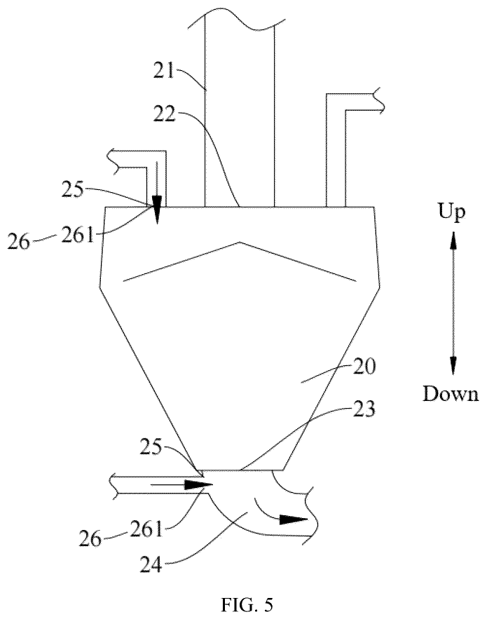

In some specific embodiments, as illustrated in FIG. 5, the at least one gas port 26 is a high-pressure gas port 261. At least one high-pressure gas port 261 is located above the discharge outlet 23.

By providing the high-pressure gas port 261 as a power source of the conveying hopper 20, the material cannot be disturbed by an external environment during conveyance, ensuring efficiency and stability of conveying the material.

The high-pressure gas port 261 is located above the discharge outlet 23. Such layout enables high-pressure gas to directly act on a material about to leave the conveying hopper 20, providing the material about to leave with sufficient power to enable it to pass smoothly through the discharge outlet 23. Meanwhile, the effect of the high-pressure gas can effectively prevent the material from being blocked or stuck during the conveyance, ensuring that the discharging process smoothly proceeds.

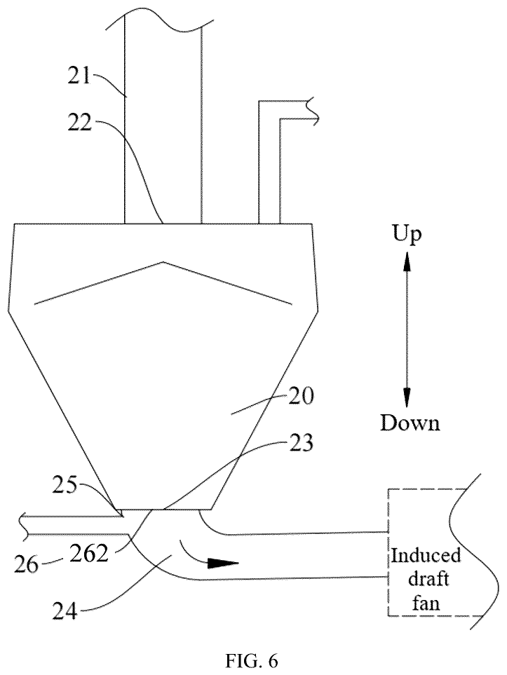

In some optional embodiments, as illustrated in FIG. 6, the gas port 26 includes a negative-pressure gas port 262, and the negative-pressure gas port 262 and the discharge outlet 23 are a same port.

The negative-pressure gas port 262 is mainly used to generate negative pressure under certain circumstances to attract the material to leave the conveying hopper 20 through the discharge outlet 23.

Optionally, the gas port 26 includes at least one high-pressure gas port 261 and a negative-pressure gas port 262. When the negative-pressure gas port 262 and the high-pressure gas port 261 operate simultaneously, the conveying hopper 20 can quickly push the material to the discharge outlet 23 by means of the high-pressure gas. Meanwhile, the negative-pressure gas port 262 can utilize a negative-pressure suction force to stably suck the material out of the discharge outlet 23. The high-pressure gas port 261 can ensure that the material passes through the discharge outlet 23 at a sufficient speed and pressure, and therefore the negative-pressure gas port 262 can effectively prevent the discharge outlet 23 from being blocked.

In some embodiments, the discharge device 100 for the sintering furnace further includes a storage material bin in communication with the discharge outlet 23 via a material conveying pipe, and the storage material bin has a tip gas outlet.

When the negative pressure is used as material conveying power, the discharge device 100 for the sintering furnace further includes an induced draft fan in communication with the tip gas outlet. The induced draft fan is configured to provide a negative-pressure suction force to the storage material bin and the conveying hopper 20, to generate a pressure difference between inside and outside of the conveying hopper 20, to allow the material inside the conveying hopper 20 to leave from the negative-pressure gas port 262 and enter the storage material bin along the material conveying pipe.

In some optional embodiments, a tip dust collector is further provided between the induced draft fan and the storage material bin to collect material dust to avoid clogging of the induced draft fan.

In an embodiment illustrated in FIG. 4, the conveying hopper 20 is provided with a pressure detection gauge, which can monitor a pressure change of the conveying hopper 20 in real time to ensure that the conveying hopper 20 operates within a normal operating range. When a pressure exceeds or falls below a predetermined safety range, the pressure detection gauge sounds an alarm to remind an operator to take a timely measure to avoid an accident.

As illustrated in FIG. 2, in the discharge device 100 according to some embodiments of the present disclosure, the conveying hopper 20 has a discharge channel 24 at the discharge outlet 23, and the high-pressure gas port 261 further satisfies at least one of following conditions:

The at least one high-pressure gas port 261 is located at the discharge outlet 23 and oriented in a discharge direction; or

The at least one high-pressure gas port 261 is located at the discharge channel 24 and oriented in the discharge direction.

When the at least one high-pressure gas port 261 is located at the discharge outlet 23 and oriented in the discharge direction, high-pressure gas coming out of the high-pressure gas port 26 has an effect of pushing the material, cleaning the discharge outlet 23, and preventing the blockage.

When the at least one high-pressure gas port 261 is located at the discharge channel 24 and oriented in the discharge direction, high-pressure gas can directly act on a surface of the material. When the high-pressure gas is ejected from the gas port, a driving force is formed by the high-pressure gas to help the material move faster and more smoothly along the discharge channel 24. This greatly reduces a risk of accumulation and the blockage of the material in the channel and ensures continuity of material discharging.

Secondly, the high-pressure gas port 261 is oriented in the discharge direction, which ensures that a gas ejection direction is consistent with a material moving direction. In this way, not only is utilization efficiency of the gas improved, but also scouring and abrasion of an inner wall of the discharge channel 24 by the gas are avoided. As a result, a service life of the equipment is prolonged.

In some embodiments not shown, at least one of a material level detector, a gas pressure detector, and a temperature detector is further included at the discharge outlet 23. With such arrangement, a safety protection mechanism can be increased, for example, to ensure that the discharge device 100 can automatically shut down or take an emergency measure under an abnormal circumstance, to prevent damage to the sintering furnace or a production accident.

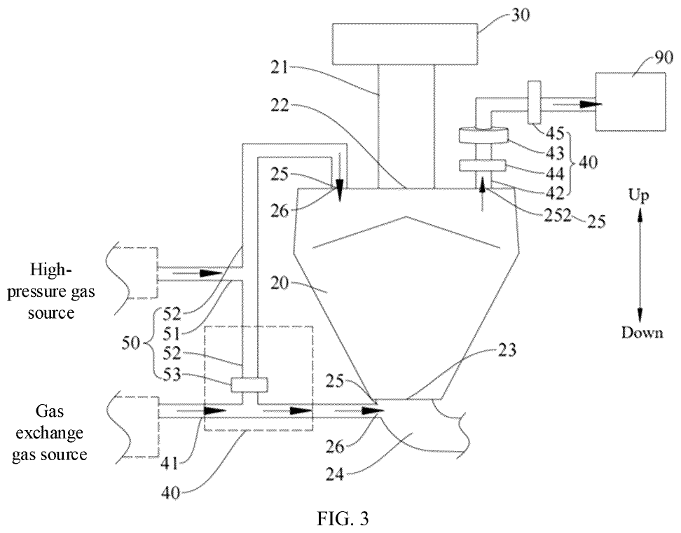

According to some embodiments of the present disclosure, the discharge device 100 further includes an intake pipe 50. As illustrated in FIG. 3, the intake pipe 50 includes a high-pressure trunk pipe 51 and at least two branch pipes 52. With such arrangement, it is ensured that the material is conveyed to the subsequent process efficiently and continuously.

The high-pressure trunk pipe 51 has an end configured to be connected to a high-pressure gas source. As a main passage of the intake pipe 50, the high-pressure trunk pipe 51 is responsible for delivering the high-pressure gas from the high-pressure gas source to the branch pipe 52.

Due to the high-pressure characteristics of high-pressure gas, the trunk pipe can ensure that the gas maintains sufficient power and stability during the delivery.

The branch pipe 52 has an end configured to be connected to another end of the high-pressure trunk pipe, and another end configured to be connected to the high-pressure gas port 261. Such a connection manner ensures that the high-pressure gas can flow smoothly from the trunk pipe into the branch pipe 52 and be further delivered to a designated position of the conveying hopper 20.

A gas-pressure regulator 53 is at least further provided at the branch pipe 52 connected to the conveying hopper 20. A flow rate and a pressure of the high-pressure gas in the high-pressure gas port 26 can be regulated by the gas-pressure regulator 53 to allow for a control of a material conveying speed. In this way, flexibility of the discharge device 100 in adapting to materials of different specifications and types is improved, and the discharge device 100 can adapt to operating environments under different production requirements.

In an embodiment illustrated in FIG. 3, the conveying hopper 20 includes two high-pressure gas ports 261. One of the two high-pressure gas ports 261 is located above the conveying hopper 20, and another one of the two high-pressure gas ports 261 is located at the discharge outlet 23 of the conveying hopper 20.

The intake pipe 50 includes a high-pressure trunk pipe 51 and two branch pipes 52. The high-pressure trunk pipe 51 has an end configured to be connected to a high-pressure gas source, and another end connected to the two branch pipes 52. One of the two branch pipes 52 is configured to be connected to the high-pressure gas port 261 at top of the conveying hopper 20, and another one of the two branch pipes 52 is configured to be connected to the high-pressure gas port 261 at the discharge outlet 23.

Correspondingly, an intake volume of compressed air can be increased, which in turn improves a material discharging speed.

In the discharge device 100 according to some embodiments of the present disclosure, as illustrated in FIGS. 2 and 3, the first gas exchange port 25 includes a first gas exchange inlet 251 and a first gas exchange outlet 252.

In some optional embodiments, at least one first gas exchange inlet 251 and the high-pressure gas port 261 are a same port.

The first gas exchange inlet 251 is configured to deliver high-pressure gas into the conveying hopper 20, facilitating the high-pressure gas to flow smoothly in the conveying hopper 20. A powerful thrust force of the high-pressure gas can effectively overcome friction and adhesion between the materials, ensuring that the materials can be discharged smoothly from the conveying hopper 20.

When the first gas exchange inlet 251 and the high-pressure gas port 261 are a same port, it is possible to avoid providing an extra gas port at the conveying hopper 20. All the gas flow can enter the conveying hopper 20 through the high-pressure gas port 261 and be managed by a gas pressure regulating valve, thereby simplifying the structure of the discharge device 100.

Each gas port is a potential leak point or a potential maintenance point, and reducing the number of gas ports means reducing potential a source of failure, thereby reducing maintenance workload.

In some other embodiments, the first gas exchange inlet 251 and the high-pressure gas port 261 may be disposed separately, or a plurality of first gas exchange inlets 251 and a plurality of first gas exchange outlets 252 may be reasonably laid out according to a shape and a volume of the conveying hopper 20 to improve the replacement efficiency.

In the discharge device 100 according to some embodiments of the present disclosure, as illustrated in FIGS. 2 and 3, the first gas exchange assembly 40 further includes a gas exchange intake channel 41. The gas exchange intake channel 41 has an end configured to be connected to the gas exchange gas source and another end configured to be connected to at least one branch pipe 52, and the gas exchange intake channel 41 is connected to the high-pressure gas port 261 disposed at the conveying hopper 20 by the branch pipe 52.

As illustrated in FIG. 3, the gas exchange intake channel 41, as a main passage of the first gas exchange assembly 40, is responsible for delivering the protective gas from the gas exchange gas source to the branch pipe 52. With such arrangement, factors such as flow rate, pressure, and stability of the protective gas are taken into account to ensure that the protective gas can flow smoothly and efficiently. In this way, the replacement efficiency of the protecting gas in the conveying hopper 20 is improved.

The branch pipe 52 branches off from the gas exchange intake channel 41, and the number of the branch pipes 52 is determined according to actual needs. The branch pipes 52 deliver the gas from the trunk pipe to the first gas exchange port 25 of the conveying hopper 20, i.e., the high-pressure gas port 261, to allow for the replacement of the protective gas.

The branch pipe 52 can ensure that the protective gas encounters minimal resistance during the delivery by reasonably designing its length and diameter. Therefore, the utilization efficiency of the protective gas is improved.

Furthermore, the branch pipe 52 may be flexibly adjusted and optimized according to different application scenarios.

Optionally, the branch pipe 52 is arranged in a straight-line configuration. In this scenario, the branch pipe 52 may be arranged in a straight line in an axial direction of the conveying hopper 20. This arrangement can ensure that the gas encounters the minimal resistance during the delivery. Therefore, the utilization efficiency of the protective gas is improved. Meanwhile, the branch pipe 52 arranged in the straight-line configuration is also convenient for installation and maintenance, which reduces complexity and maintenance cost of the discharge device 100.

Optionally, the branch pipe 52 is arranged in a branched configuration. By setting branch points at different positions, the protective gas can be diverted to different directions. This arrangement can ensure that the protective gas is evenly distributed inside the conveying hopper 20, thereby improving the effect of gas replacement.

In addition, the branch pipe 52 is connected to the high-pressure gas port 261. Thus, efficient gas intake is realized by using an injection angle of the high-pressure gas port 261, facilitating management. Furthermore, the gas flow is more concentrated and orderly, and a risk of gas leakage is also reduced.

The discharge device 100 according to some embodiments of the present disclosure further includes a dust removal system 90. As illustrated in FIGS. 2 to 4, the dust removal system 90 is connected to the first gas exchange port 25. Gas output from the conveying hopper 20 is delivered to the dust removal system 90 through the first gas exchange port 25.

The dust removal system 90 mainly aims to collect material dusts in the gas output from the conveying hopper 20. These dusts are mainly raised dusts generated during the conveyance of the material. Through the dust removal system 90, it can be ensured that these dusts are not directly discharged into the environment together with the gas, thus protecting the environment and ensuring compliance with environmental protection requirements.

In some embodiments, as illustrated in FIGS. 2 and 3, the dust removal system 90 is connected to the first gas exchange outlet 252 of the first gas exchange port 25.

Then, after the protective gas enters the conveying hopper 20, due to a driving effect of the protective gas, original air in the conveying hopper 20 is gradually squeezed and flows into the dust removal system 90 through the first gas exchange outlet 252, and discharged uniformly after dust removal.

In some embodiments, as illustrated in FIG. 4, the material bin 10 has an inlet 11, an outlet 13, and a second gas exchange port 14. The outlet 13 is in communication with the feed channel 21, and the inlet 11 is in communication with the body of the sintering furnace.

The inlet 11 serves as a passage through which the material enters the material bin 10, and the inlet 11 is connected to the body of the sintering furnace to ensure that the material can be smoothly transferred from the sintering furnace to the material bin 10. The outlet 13 serves as a passage through which the material leaves the material bin 10, and the outlet 13 is connected to the feed channel 21 to allow the material to smoothly enter a next processing stage.

The discharge device 100 further includes a second valve assembly 60 and a second gas exchange assembly 70.

The second valve assembly 60 is configured to control opening or closing of the inlet 11. For the sintering furnace with intermittent production, when it is necessary to add a material to the material bin 10, the second valve assembly 60 may be opened. When material discharging is completed or a material quantity in the material bin 10 reaches a predetermined value, the second valve assembly 60 is closed by the system to realize precise control of entry of the material into the material bin 10. For sintering furnace with continuous production, such as a rotary sintering furnace for lithium iron phosphate, etc., the material bin 10 is ventilated before starting production, and the second valve assembly 60 is in a normally open state during a production stage.

As illustrated in FIG. 4, the second gas exchange assembly 70 is connected to the second gas exchange port 14. The second gas exchange assembly 70 is configured to output gas in the material bin 10 through the second gas exchange port 14 and deliver protective gas into the material bin 10. The protective gas delivered into the material bin is same as protective gas inside the body. The gas inside the material bin 10 can be replaced or regulated through the second gas exchange port 14, thereby ensuring that the material is in an atmosphere of the protective gas in the material bin 10.

The second valve assembly 60 may be a manually controlled valve or an electrically controlled valve.

In some embodiments, as illustrated in FIG. 4, the controller 80 is electrically connected to the second gas exchange assembly 70, the first valve assembly 30, and the second valve assembly 60. Automation and intelligence of the discharge device 100 are improved by the controller 80. Through the electrical connection, not only can precise control of the first valve assembly 30 and the second valve assembly 60 be realized, but also the controller 80 can adjust an operating state of the second gas exchange assembly 70 in real time.

Before starting production, when the first valve assembly 30 is in a closed state, the controller 80 can send an instruction to the second gas exchange assembly 70 to activate the second gas exchange assembly 70. This aims to exhaust the air in the material bin 10 through the second gas exchange port 14 to allow the material bin 10 to be filled with the protective gas, to prepare for entry of the material during the production.

Optionally, the controller 80 can adjust operating parameters of the second gas exchange assembly 70, such as gas flow rate, gas exchange duration, etc., according to actual needs to meet different production requirements.

Optionally, the second gas exchange assembly 70 further includes a second gas filter 71 and a fourth gas exchange control valve 72.

The second gas filter 71 is configured to intercept the dust in the output gas.

The fourth gas exchange control valve 72 is configured to control a flow rate of the gas flow discharged from the second gas exchange port 14 to adjust the gas pressure inside the material bin 10.

The dust removal system 90 is connected to the second gas exchange port 14, and the gas output from the material bin 10 is delivered to the dust removal system 90 through the second gas exchange port 14. In this way, it can be ensured that the gas output from the material bin 10 is effectively processed by the dust removal system 90. Thus, it is ensured that the gas after dust removal is clean and meets the environmental protection requirements.

In the discharge device 100 according to some embodiments, as illustrated in FIG. 4, the first gas exchange assembly 40 further includes a first gas exchange channel 42, a first gas filter 43, a first gas exchange control valve 44, and a second gas exchange control valve 45.

The first gas exchange channel 42 has an end in communication with the first gas exchange port 25. The first gas exchange channel 42 is configured to be connected to the first gas exchange port 25 and the dust removal system 90. It provides a smooth channel such that the gas output from the conveying hopper 20 can smoothly enter the dust removal system 90 for further processing.

The first gas filter 43 is disposed at the first gas exchange channel 42. The first gas filter 43 is configured for physical filtration and may also be equipped with adsorbents, which can effectively remove harmful gas in the output gas. When the gas output from the conveying hopper 20 passes through the adsorbents, the harmful gas is adsorbed on surfaces of the adsorbents and no longer circulates, which serves a function in protecting the environment. Moreover, it is possible to reduce corrosion and damage of the harmful gas to the equipment, prolong a service life of the dust removal system 90, and improve operation efficiency of the entire discharge device 100.

The first gas exchange control valve 44 is disposed at the first gas exchange channel 42 and is located upstream of the first gas filter 43. The first gas exchange control valve 44 is configured to control a flow rate of gas entering the first gas filter 43. By regulating an opening degree of the valve, the flow rate and a flow velocity of the gas can be accurately controlled to avoid overloading or underloading of the filter, thereby ensuring that the first gas filter 43 can operate stably and efficiently.

In order to increase production capacity, a plurality of sintering furnaces is typically arranged in parallel in an actual production process. In order to save resources, the discharge devices 100 for the plurality of sintering furnaces mostly adopt a same dust removal system 90 to synchronously provide gas exchange gas source power to the material bins 10 and the conveying hoppers 20 of the plurality of sintering furnaces and perform gas exchange exhaust gas treatment. However, the discharge devices 100 for different sintering furnaces differ in gas exchange timing. Therefore, when the discharge device 100 for a certain sintering furnace is performing gas exchange, the discharge device 100 for another sintering furnace in communication with the same dust removal system 90 does not need to perform gas exchange, and the corresponding first gas exchange control valve 44 is closed, while the dust removal system 90 is constantly turned on. In this way, it is possible to continuously generate a negative pressure on the first gas filter 43 through the first gas exchange channel 42, which may easily cause the first gas filter 43 to be overloaded and affect its service life.

To this end, in some embodiments, the second gas exchange control valve 45 is disposed at the first gas exchange channel 42 and is located downstream of the first gas filter 43. The second gas exchange control valve 45 is mainly configured to regulate a pressure of gas treated by the first gas filter 43. The pressure of the gas can be adjusted by controlling an opening degree of the valve. When no gas exchange is required, it is possible to avoid that the dust removal system 90 continuously generates the negative pressure, which would otherwise cause the gas filter 43 to be overloaded.

Meanwhile, the first gas exchange control valve 44 and the second gas exchange control valve 45 can also serve functions in isolation and protection. When the first gas filter 43 needs to be replaced or repaired, the first gas filter 43 can be isolated by closing the first gas exchange control valve 44 and the second gas exchange control valve 45 to prevent the gas from directly flowing in or out. Thus, safety of an operator is protected, and maintenance efficiency is improved.

In the discharge device 100 according to some embodiments of the present disclosure, as illustrated in FIGS. 1 and 4, the conveying hopper 20 is located below the material bin 10, the feed inlet 22 is located at a top of the conveying hopper 20, and the discharge outlet 23 is located at a bottom of the conveying hopper 20.

During the material discharging process, the material falls from the material bin 10 to the conveying hopper 20 by its own gravity and is discharged through the discharge outlet 23 at the bottom of the conveying hopper 20. With such arrangement, the discharging process is simplified, and energy resource consumption and the maintenance cost are lowered.

In the present disclosure, the protective gas adopts an inert gas. The inert gas includes, but is not limited to, nitrogen, helium, argon, and a mixture thereof. Adopting the inert gas can prevent lithium iron phosphate from undergoing an oxidation reaction during high-temperature sintering, thereby affecting the purity of the material. Meanwhile, a negative impact on electrochemical properties of the material is avoided.

Preferably, nitrogen is adopted as the protective gas. Nitrogen can effectively remove oxygen in the discharge device 100, thereby inhibiting the occurrence of the oxidation reaction and ensuring the purity of the material.

Hereinafter, referring to FIGS. 1 to 4, a discharge device 100 according to a specific embodiment of the present disclosure will be described.

Referring to FIGS. 1 to 4, the discharge device 100 includes a material bin 10, a conveying hopper 20, a first valve assembly 30, a first gas exchange assembly 40, an intake pipe 50, a second valve assembly 60, a second gas exchange assembly 70, a controller 80, and a dust removal system 90.

Referring to FIGS. 2 and 3, the conveying hopper 20 includes a feed channel 21, a feed inlet 22, a discharge outlet 23, a discharge channel 24, a first gas exchange port 25, and two high-pressure gas ports 261.

The conveying hopper 20 is located below the material bin 10. The feed inlet 22 is located at a top of the conveying hopper 20. The discharge outlet 23 is located at a bottom of the conveying hopper 20.

A feed channel 21 is disposed between the feed inlet 22 and the material bin 10 and connected to the feed inlet 22 and the material bin 10. The first valve assembly 30 is disposed at the feed channel 21 and is configured to control opening or closing of the feed channel 21.

The first gas exchange assembly 40 is connected to the first gas exchange port 25. The first gas exchange assembly 40 is configured to output gas from the first gas exchange port 25 and deliver protective gas into the conveying hopper 20.

The conveying hopper 20 has a discharge channel 24 at the discharge outlet 23.

One of the two high-pressure gas ports 261 is disposed above the discharge outlet 23, located at an inner wall of the discharge channel 24, and faces towards a discharge direction. Another one of the two high-pressure gas port 261 is located at the discharge outlet 23 and oriented in the discharge direction.

The intake pipe 50 includes a high-pressure trunk pipe 51, two branch pipes 52, and a gas-pressure regulator 53.

The high-pressure trunk pipe 51 has an end configured to be connected to a high-pressure gas source and another end configured to be connected to the two branch pipes 52.

One of the two branch pipes 52 has an end connected to another end of the high-pressure trunk pipe, and another end configured to be connected to the high-pressure gas port 261. The gas-pressure regulator 53 is disposed at the above branch pipe 52.

The first gas exchange port 25 includes two first gas exchange inlets 251 and a first gas exchange outlet 252.

The two first gas exchange inlets 251 correspond to the two high-pressure gas ports 261, respectively.

The first gas exchange assembly 40 includes a gas exchange intake channel 41, a first gas exchange channel 42, a first gas filter 43, a first gas exchange control valve 44, and a second gas exchange control valve 45.

The gas exchange intake channel 41 is in communication with the first gas exchange inlet 251.

The first gas exchange channel 42, the first gas filter 43, the first gas exchange control valve 44, and the second gas exchange control valve 45 are in communication with the first gas exchange outlet 252.

The gas exchange intake channel 41 has an end configured to be connected to a gas exchange gas source and another end configured to be connected to the two branch pipes 52.

The material bin 10 includes an inlet 11, an outlet 13, and a second gas exchange port 14.

The inlet 11 is in communication with a body of the sintering furnace. The outlet 13 is in communication with the feed channel 21 of the conveying hopper 20.

The second valve assembly 60 is configured to control opening or closing of the inlet 11 of the material bin 10.

The second gas exchange assembly 70 includes a second gas filter 71 and a fourth gas exchange control valve 72.

The fourth gas exchange control valve 72 is connected to the second gas exchange port 14. The second gas filter 71 is disposed downstream of the fourth gas exchange control valve 72.

Referring to FIG. 4, the controller 80 is electrically connected to each of the first gas exchange assembly 40, the second gas exchange assembly 70, the first valve assembly 30, and the second valve assembly 60.

Referring to FIG. 4, the dust removal system 90 is connected to each of the first gas exchange outlet 252 and the second gas exchange port 14.

The first gas exchange channel 42 has an end in communication with the first gas exchange port 25. The first gas filter 43 is disposed at the first gas exchange channel 42. The first gas exchange control valve 44 and the second gas exchange control valve 45 are both disposed at the first gas exchange channel 42, and are located upstream and downstream of the first gas filter 43, respectively.

The first valve assembly 30 includes a feed valve 31, a first feed control valve 32, a second feed control valve 33, and a third feed control valve 34 which are disposed at the feed channel 21.

The first feed control valve 32 is located upstream of the feed valve 31, and the second feed control valve 33 and the third feed control valve 34 are sequentially located downstream of the feed valve 31.

Other compositions such as the sintering furnace and the like, and operations of the discharge device according to the embodiments of the present disclosure are known to those skilled in the art, and details thereof will be omitted herein.

In the description of the present disclosure, it is to be understood that, the terms such as “over”, “below”, “top”, “bottom”, “in”, “out”, “axial”, etc., are based on the orientation or position relationship shown in the drawings, and is only for the convenience of describing the present disclosure and simplifying the description, rather than indicating or implying that the associated device or element must have a specific orientation, or be constructed and operated in a specific orientation, and therefore cannot be understood as a limitation on the present disclosure.

In addition, the terms such as “first” and “second” are used herein for purposes of description and are not intended to indicate or imply relative importance, or to implicitly show the number of indicated technical features. Thus, the feature defined with “first” and “second” may explicitly or implicitly include one or more of this feature. In the description of the present disclosure, “a plurality of” means two or more, unless specified otherwise.

In the present disclosure, unless specified or limited otherwise, the terms “mounted”, “connected”, “coupled” and “fixed” are understood broadly, such as fixed, detachable mountings, connections and couplings or integrated, and can be mechanical or electrical mountings, connections and couplings, and also can be direct and via media indirect mountings, connections, and couplings, and further can be inner mountings, connections and couplings of two components or interaction relations between two components, which can be understood by those skilled in the art according to the detail embodiment of the present disclosure.

In the present disclosure, unless specified or limited otherwise, the first characteristic is “on” or “under” the second characteristic means that the first characteristic and the second characteristic can be in direct contact or in indirect contact through another feature between them. And, the first characteristic is “on”, “above”, “over” the second characteristic means that the first characteristic is right over the second characteristic or is diagonal above the second characteristic, or simply means that the horizontal height of the first characteristic is higher than the horizontal height of the second characteristic. The first characteristic is “below” or “under” the second characteristic means that the first characteristic is right over the second characteristic or is diagonal under the second characteristic, or simply means that the horizontal height of the first characteristic is lower than the horizontal height of the second characteristic.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art, unless they are contradictory to each other.

Although embodiments of the present disclosure have been shown and described, it would be appreciated by those skilled in the art that the above embodiments are exemplary and cannot be construed to limiting the present disclosure, and changes, modifications, alternatives, and alterations can be made to the embodiments without departing from scope of the present disclosure.

What is claimed is:

1. A discharge device for a sintering furnace, the discharge device comprising:
a material bin configured to be connected to a body of the sintering furnace to collect sintered material;
a conveying hopper having a feed inlet, a discharge outlet, and a first gas exchange port, a feed channel being disposed between the feed inlet and the material bin and connected to the feed inlet and the material bin;
a first valve assembly disposed at the feed channel and configured to control opening or closing of the feed channel;
a first gas exchange assembly connected to the first gas exchange port, the first gas exchange assembly being configured to output gas from the first gas exchange port and deliver protective gas into the conveying hopper, the protective gas delivered into the conveying hopper being same as protective gas inside the body; and
a controller electrically connected to the first gas exchange assembly and the first valve assembly to control the first gas exchange assembly to be activated when the conveying hopper has completed conveying and the first valve assembly is closed.

2. The discharge device according to claim 1, wherein:
the conveying hopper has at least one gas port for generating a pressure difference between inside and outside of the conveying hopper to convey the material; and
the at least one gas port is a high-pressure gas port, at least one high-pressure gas port being located above the discharge outlet.

3. The discharge device according to claim 2, wherein:
the conveying hopper has a discharge channel at the discharge outlet; and
the high-pressure gas port further satisfies at least one of following conditions:
the at least one high-pressure gas port is located at the discharge outlet and oriented in a discharge direction; or
the at least one high-pressure gas port is located at the discharge channel and oriented in the discharge direction.

4. The discharge device according to claim 2, further comprising an intake pipe, wherein the intake pipe comprises:
a high-pressure trunk pipe having an end configured to be connected to a high-pressure gas source; and
at least two branch pipes, wherein each of the at least two branch pipes has an end configured to be connected to another end of the high-pressure trunk pipe and another end configured to be connected to the high-pressure gas port,
wherein a gas-pressure regulator is at least further provided at the branch pipe connected to the conveying hopper.

5. The discharge device according to claim 4, wherein:
the first gas exchange port comprises a first gas exchange inlet and a first gas exchange outlet; and
the first gas exchange assembly further comprises a gas exchange intake channel, wherein the gas exchange intake channel has an end configured to be connected to a gas exchange gas source and another end configured to be connected to at least one first gas exchange inlet.

6. The discharge device according to claim 5, wherein:
the at least one first gas exchange inlet and the high-pressure gas port disposed at the conveying hopper are a same port;
the end of the gas exchange intake channel is configured to be connected to the gas exchange gas source, and the other end of the gas exchange intake channel is configured to be connected to at least one of the at least two branch pipes; and
the gas exchange intake channel is connected to the high-pressure gas port disposed at the conveying hopper through the at least one of the at least two branch pipes.

7. The discharge device according to claim 1, wherein:
the conveying hopper has at least one gas port for generating a pressure difference between inside and outside of the conveying hopper to convey the material; and
the at least one gas port is a negative-pressure gas port, the negative-pressure gas port and the discharge outlet being a same port.

8. The discharge device according to claim 1, wherein the first valve assembly at least comprises a plurality of control valves arranged at the feed channel, the plurality of control valves comprising a feed valve, a first feed control valve, a second feed control valve, and a third feed control valve, wherein:
the first feed control valve is located upstream of the feed valve;
the second feed control valve and the third feed control valve are located downstream of the feed valve; and
an inter-valve gas pressure detector is provided between the second feed control valve and the third feed control valve that are located downstream of the feed valve.

9. The discharge device according to claim 1, further comprising a dust removal system connected to the first gas exchange port, wherein gas output from the conveying hopper is delivered to the dust removal system through the first gas exchange port.

10. The discharge device according to claim 9, wherein:
the material bin has an inlet in communication with the body of the sintering furnace, an outlet in communication with the feed channel, and a second gas exchange port;
the discharge device further comprises:
a second valve assembly configured to control opening or closing of the inlet; and
a second gas exchange assembly connected to the second gas exchange port, the second gas exchange assembly being configured to output gas inside the material bin through the second gas exchange port and deliver protective gas into the material bin, the protective gas delivered into the material bin being same as the protective gas inside the body;
the controller is electrically connected to the second gas exchange assembly and the first valve assembly to control the second gas exchange assembly to be activated when the material has been conveyed to the conveying hopper from the material bin and the first valve assembly and the second valve assembly are both closed; and
the dust removal system is connected to the second gas exchange port, and the gas output from the material bin is delivered to the dust removal system through the second gas exchange port.

11. The discharge device according to claim 1, wherein the first gas exchange assembly further comprises:
a first gas exchange channel having an end in communication with the first gas exchange port;
a first gas filter disposed at the first gas exchange channel;
a first gas exchange control valve disposed at the first gas exchange channel and located upstream of the first gas filter; and
a second gas exchange control valve disposed at the first gas exchange channel and located downstream of the first gas filter.

12. The discharge device according to claim 1, wherein:
the conveying hopper is located below the material bin;
the feed inlet is located at a top of the conveying hopper; and
the discharge outlet is located at a bottom of the conveying hopper.
